(19) United States
(12) Patent Application Publication
(10) Pub. No.: US 2012/0133657 A1
(43) Pub. Date: May 31, 2012

(54) REQUIREMENT STRUCTURE DISPLAY APPARATUS AND COMPUTER READABLE MEDIUM

(75) Inventors: Hajime UENO, Kanagawa (JP); Toshiroh SHIMADA, Kanagawa (JP); Atsushi ITO, Kanagawa (JP); Ichiro YAMAURA, Kanagawa (JP)

(73) Assignee: FUJI XEROX CO., LTD., Tokyo (JP)

(21) Appl. No.: 13/087,964

(22) Filed: Apr. 15, 2011

(30) Foreign Application Priority Data
Nov. 26, 2010 (JP) 2010-263681

(51) Int. Cl. G06T 11/20

(52) U.S. Cl. 345/440

(57) ABSTRACT

A requirement structure display apparatus includes a graph display information generation unit that generates graph display information representing a graph constituted by the parent-child relationships; a first specification acceptance unit that accepts a specification of the requirement data or the strategy data of an object in interest in the graph represented by the graph display information generated by the graph display information generation unit; a part-in-interest display information generation unit that generates part-in-interest display information; and a display control unit that controls a display by a display unit so as to be switched from a display based on the graph display information generated by the graph display information generation unit to a display based on the part-in-interest display information generated by the part-in-interest display information generation unit based on the object in interest accepted by the first specification acceptance unit.

### CROSS-REFERENCE TO RELATED APPLICATION

This application is based on and claims priority under 35 USC 119 from Japanese Patent Application No. 2010-263681 filed on Nov. 26, 2010.

### BACKGROUND

### Technical Field

The present invention relates to a requirement structure display apparatus and a computer readable medium.

### SUMMARY

According to an aspect of the invention, a requirement structure display apparatus includes:

a graph display information generation unit that, with reference to a storage unit that stores information concerning a parent-child relationship where requirement data is a parent and strategy data for refining the requirement data is a child and a parent-child relationship where the strategy data is a parent and at least one piece of requirement data obtained by refining the requirement data according to the strategy is a child, generates graph display information representing a graph constituted by the parent-child relationships between the requirement data and the strategy data;

a first specification acceptance unit that accepts a specification of the requirement data or the strategy data of an object in interest in the graph represented by the graph display information generated by the graph display information generation unit;

a part-in-interest display information generation unit that generates part-in-interest display information representing, in a direction of the parent-child relationship, the object in interest a specification of which is made to the first specification acceptance unit and a direct parent and direct child of the object in interest obtained from the information concerning the parent-child relationships stored in the storage unit; and

a display control unit that controls a display by a display unit so as to be switched from a display based on the graph display information generated by the graph display information generation unit to a display based on the part-in-interest display information generated by the part-in-interest display information generation unit based on the object in interest accepted by the first specification acceptance unit, according to the acceptance of the specification of the requirement data or the strategy data of the object in interest by the first specification acceptance unit.

### BRIEF DESCRIPTION OF THE DRAWINGS

Embodiments of the invention will be described in detail based on the following figures, wherein:

FIG. 1 is a view showing an example in which a requirement structure is expressed as a graph (tree) structure of the D-Case;

FIG. 2 is a view showing an example of the structure of an apparatus of an exemplary embodiment;

FIG. 3 is a view showing an example of the data contents in a requirement structure storage portion;

FIG. 4 is a view showing an example of a part-in-interest display;

FIG. 5 is a view showing another example of the part-in-interest display;

FIG. 6 is a view showing still another example of the part-in-interest display; and

FIG. 7 is a view showing yet another example of the part-in-interest display.

### DETAILED DESCRIPTION

Hereinafter, an apparatus will be described for displaying a structure, required of systems and apparatuses, in which requirements as to reliability, safety, dependability and the like are refined to reach verification means or a verification result in the end (hereinafter, this structure will be referred to as a requirement structure).

With a graph described by the D-Case as an example of the requirement structure, an example of an apparatus for displaying this graph will be described. As also shown in the above document of “D-Case”, the D-Case is a structured document used to obtain an agreement between stakeholders in various scenes of a system life cycle.

It is to be noted that the use of the D-Case is merely an example, and the system of the exemplary embodiment shown below may be applied to a document describing a requirement structure in a different format.

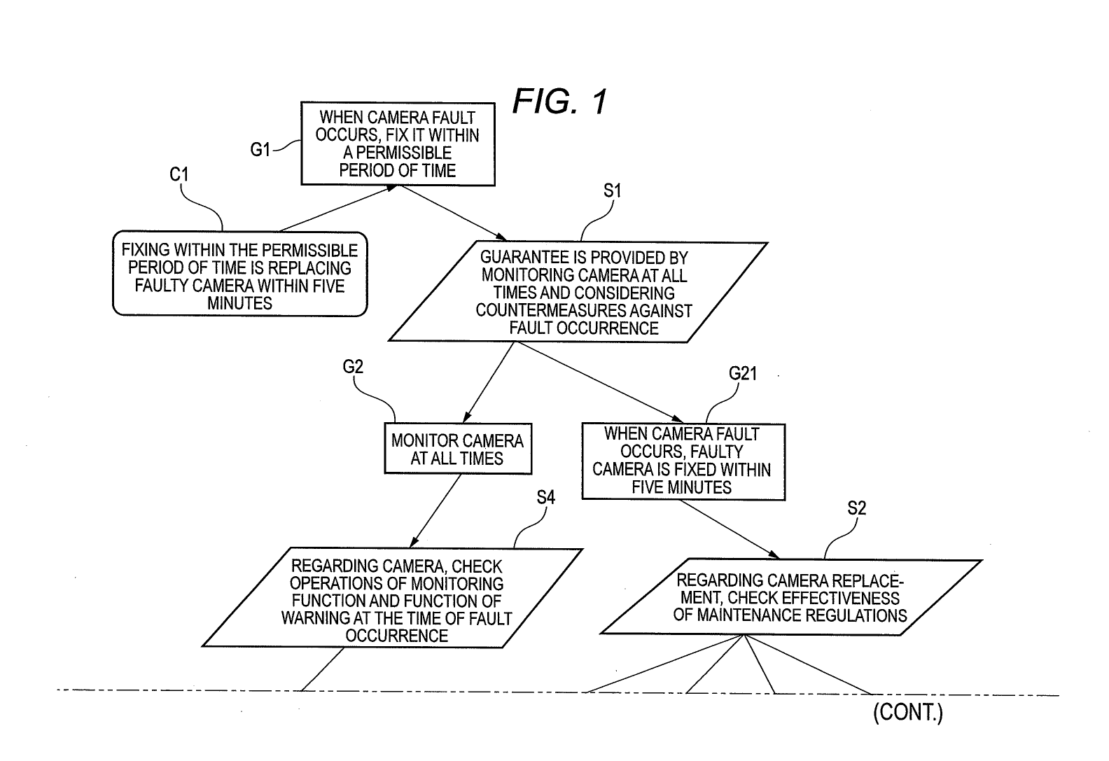

FIG. 1 shows an example of the requirement structure described by the D-Case. This example shows a result of refining and breaking down a fundamental requirement (target for achievement) “when a camera fault occurs, fix it within a permissible period of time.”

According to the D-Case, a requirement (a solution depending on the viewpoint) is called a “goal”. When the requirement may not be realized as it is, a requirement more refined or broken down (hereinafter, collectively referred to as refined) for realizing the requirement is devised. That is, a requirement may be divided into one or more requirements that are more refined. The latter requirement (goal) is sometimes called a sub-goal with respect to the former requirement (goal).

When a goal is refined into one or more sub-goals, it is beneficial not to haphazardly devise sub-goals but to determine a policy for refinement and devise sub-goals in line with the policy. Accordingly, the D-Case is capable of describing such a policy for refinement (that is, division of a goal into sub-goals). Such a policy is called “strategy”. That is, a goal is capable of being divided into one or more sub-goals according to a certain strategy. In this case, the following parent-child relationships are considered: a parent-child relationship where a goal is a parent and a strategy is a child; and a parent-child relationship where a strategy is a parent and a sub-goal is a child (thus, the sub-goal is a grandchild for the goal).

The D-Case also describes, when a goal is realizable (that is, requires no more refinement), an evidence that the goal is actually realizable. The data of this evidence is called “evidence”. Moreover, there are cases where as the evidence, not static data but an actually operating apparatus or software module is monitored and the operating condition of the apparatus, etc. is dynamically obtained and presented. Such a dynamic monitoring result is called “monitor” so as to be distinguished from the static “evidence”. In this case, a parent-child relationship is considered where a goal is a parent and an evidence or a monitor is a child.

Moreover, the D-Case has a function of associating comments with data items such as a goal, a strategy, an evidence and a monitor. In this case, a parent-child relationship is considered where the goal, the strategy, the evidence or the monitor is a parent and the comment is a child.

The requirement structure described by the D-Case is expressed as a directed graph where the above-mentioned goal, strategy, evidence, monitor and comment are nodes and the parent-child relationships that hold therebetween are edges. The direction of the edge of the directed graph is, for example, a direction from a parent node toward a child node. When the number of parents of a node is limited to one, the requirement structure is expressed as a tree structure.

FIG. 1 shows such a requirement structure as a directed graph (a tree in the example of FIG. 1). In FIG. 1, goals are represented by reference designation “Gn” (n is a natural number. The same applies hereinafter); strategies, by reference designation “Sn”; evidences, by reference designation “En”; a monitor, by reference designation “Mn”; and a comment, by reference designation “Cn”.

The graph of FIG. 1 is merely a very simple example for explanation, and the actual system requirement structures are far and away larger in scale and more complicated than this. Therefore, a system that displays a requirement structure as a graph as it is as in FIG. 1 generally requires an extremely large display area to display the whole image. When the whole image of the graph is displayed, a multiplicity of nodes line up to complicate the display image.

Therefore, the requirement structure display apparatus of the present exemplary embodiment generates a display to show a part, in which the user is interested, of such a requirement structure graph in an easier-to-understand manner.

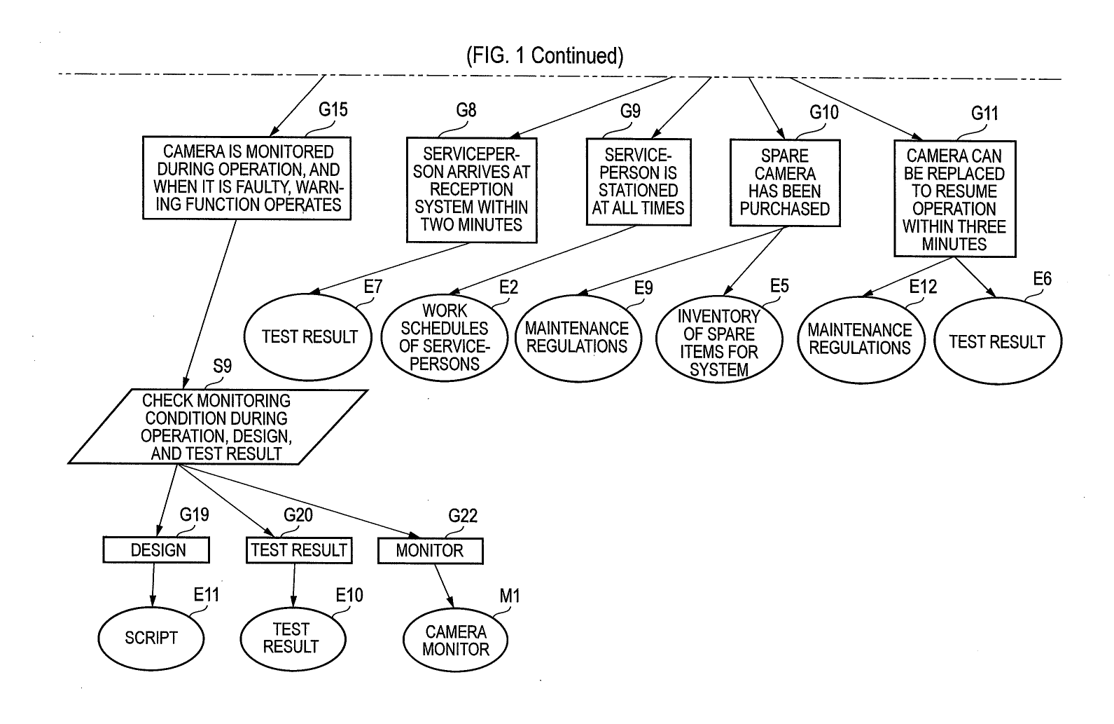

FIG. 2 schematically shows an example of the structure of the requirement structure display apparatus of the present exemplary embodiment. This requirement structure display apparatus is provided with a requirement structure storage portion 10, a display information generation portion 20, a display device 26 and an input device 28.

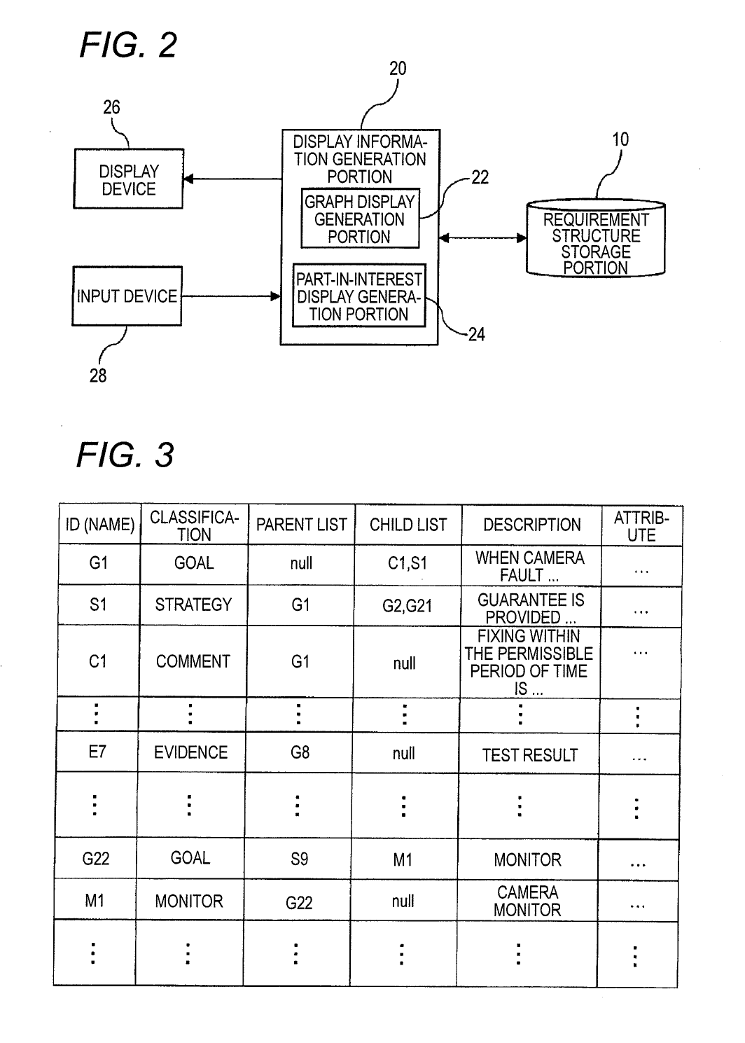

The requirement structure storage portion 10 stores data that defines a requirement structure as illustrated in FIG. 1. FIG. 3 shows part of the data representing the requirement structure of FIG. 1. Each row of the table shown in FIG. 3 shows the information concerning a node of the requirement structure. In the illustrated example, the records of one row include “ID”, “classification”, “parent list”, “child list”, “description”, and “attribute” as items. The item “ID” is identification information for uniquely identifying the node, and the name of the node, for example, may be used. The item “classification” shows whether the node is a goal, a strategy, an evidence, a monitor, or a comment. The item “parent list” is a list of the ID of the parent node of the node. When the requirement structure is expressed as a tree structure, the parent list includes one ID at most. The item “child list” is a list of the ID of the child node of the node. The item “description” is data (for example, character string data) representing the contents of the description of the node. For example, in the case of a goal node, the item “description” includes a character string representing the contents of the requirement, and in the case of a strategy node, the item “description” includes a character string representing the contents of the refinement strategy. The item “attribute” includes various attribute items of the node. For example, in the case of an evidence node, the item “attribute” includes a link (e.g. URL [uniform resource locator]) to the actual data representing an evidence. In the case of a monitor mode, the item “attribute” includes a link (e.g. information including the address of the module, the communication procedure, and the like) to the actual module (apparatus or software) to be monitored.

It is to be noted that FIG. 3 is merely an example of the data structure representing the requirement structure and a different data structure may be used.

The display information generation portion 20 generates a display image to display the requirement structure based on the requirement structure data stored in the requirement structure storage portion 10. While in FIG. 1, an example is shown in which the requirement structure storage portion 10 and the display information generation portion 20 are included in the same apparatus, a structure may be adopted in which these portions are present on different apparatuses and access each other through a data communication network. Moreover, a structure may be adopted in which the requirement structure storage portion 10 and the display information generation portion 20 are provided on a Web server and the browser of a client apparatus accesses the Web server, obtains graph display information and part-in-interest display information described later and displays them. In this case, the display device 26 and the input device 28 in FIG. 2 correspond to the browser, the display and the input device such as a mouse of the client apparatus.

In the illustrated example, the display information generation portion 20 is provided with a graph display generation portion 22 and a part-in-interest display generation portion 24.

The graph display generation portion 22 generates graph display information to ordinarily display the requirement structure stored in the requirement structure storage portion 10, in a graph form as in FIG. 1. The generated display information is displayed on the screen of the display device 26 such as a liquid crystal display or a touch panel display. When the area of the image of the graph represented by the graph display information is larger than the area of the display screen of the display device, the graph is scroll-displayed. In the graph display information, the shapes of the figures representing the nodes differ according to the classifications of the nodes as illustrated in FIG. 1, and the parent-child relationships between the nodes are represented, for example, by arrows. Moreover, each node included in the graph display information is associated with link information for calling a part-in-interest display centered on the node. When a node in the graph display information displayed on the display device 26 is selected with the input device 28 such as a mouse or a touch sensor of a touch panel, the part-in-interest display generation portion 24 is called, and a part-in-interest display centered on the selected node (that is, the node in interest) is provided.

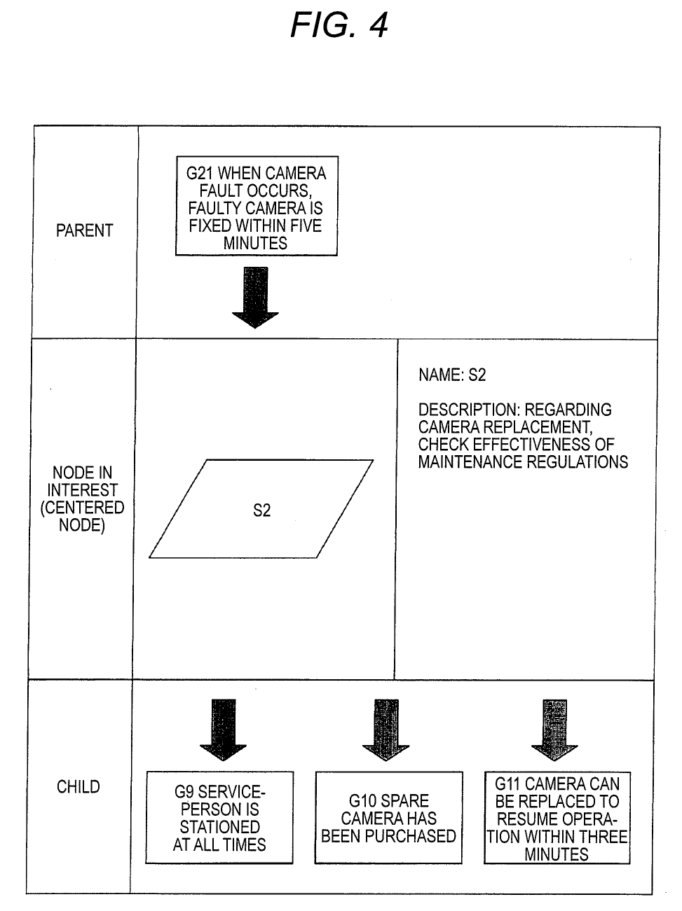

The part-in-interest display generation portion 24 generates part-in-interest display data centered on, of the nodes in the requirement structure graph, the node in interest selected by the user. An example of the part-in-interest display image displaying the part-in-interest display data is schematically shown in FIG. 4. In the example of FIG. 4, the part-in-interest display image has a display column for the node in interest in the center, and has display columns for the parent and child nodes of the node in interest above and below it. That is, in the example of FIG. 4, a parent node, a node in interest and child nodes are aligned in this order from above in an ancestor-descendant direction. It is to be noted that aligning the node in interest and its parent and children in a longitudinal direction as shown in FIG. 4 is merely an example and these may be aligned in a different direction such as a lateral direction.

As described above, the part-in-interest display image shows the flow of the requirement refinement such that which node the node in interest is derived from and which node is derived from the node in interest.

The part-in-interest display generation portion 24 obtains the information concerning the selected node in interest and the direct parent and children of the node in interest from the requirement structure storage portion 10, and generates part-in-interest display information representing the image illustrated in FIG. 4.

The display column for the node in interest in the center of FIG. 4 includes a first column for displaying the figure image of the node in interest and a second column for displaying the name (ID), description and other attributes of the node in interest. On the other hand, in the display columns of the node of the direct parent (referred to as a parent node) and the nodes of the direct children (referred to as child nodes) of the node in interest, the node figures in which the names and the descriptions are shown are displayed so as to be aligned in a longitudinal direction. When the numbers of parent nodes and child nodes are too large to be displayed within the width of the display columns, the display columns are scroll-displayed so that all the nodes are displayed. For example, the names and descriptions of the parent and child nodes are displayed in a font smaller than the name and description of the node in interest displayed in the second column.

The parent nodes and the child nodes in the part-in-interest display image are each associated with link information for calling the part-in-interest display centered on the node. When a node in the part-in-interest display information displayed on the display device 26 is selected by the input device 28, the part-in-interest display generation portion 24 generates a part-in-interest display centered on the selected new node in interest.

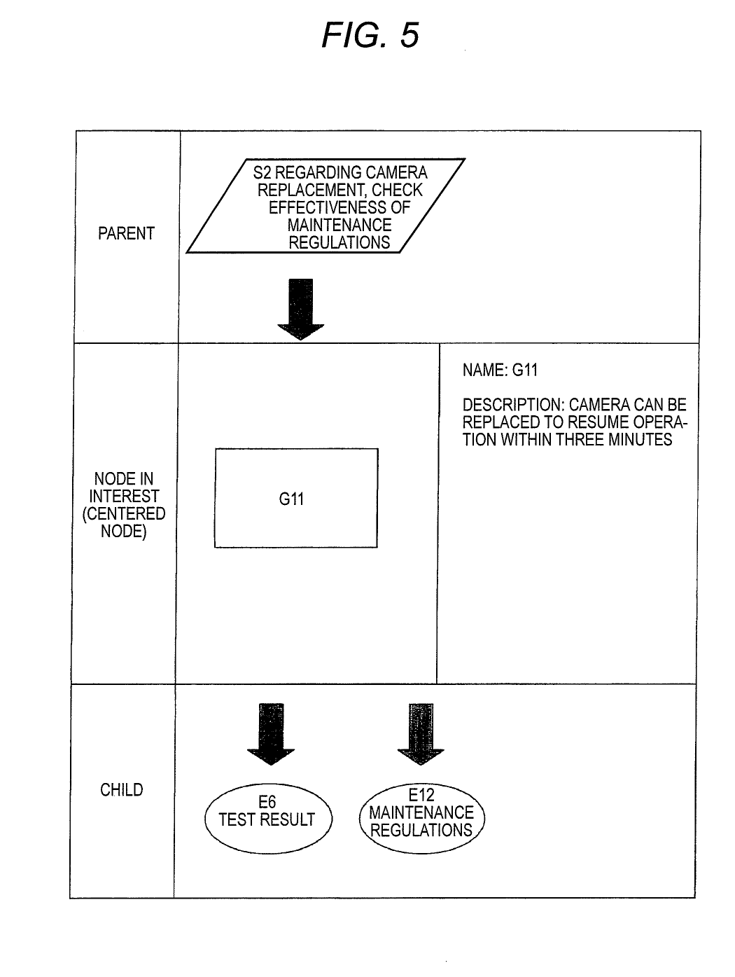

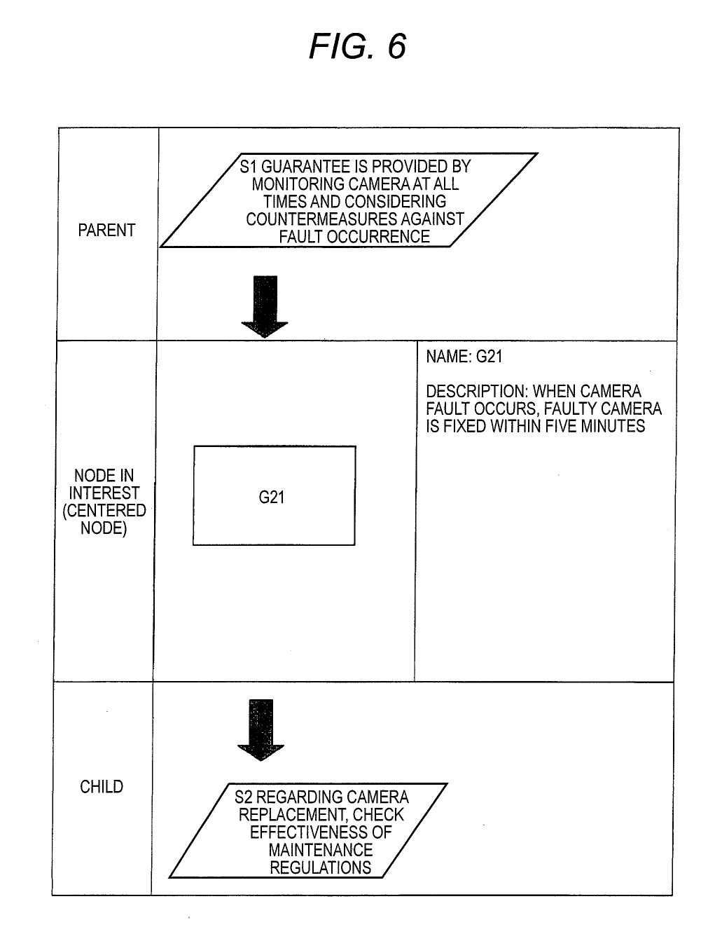

For example, when the user selects, for example, the child node G11 by, for example, tapping a touch panel in the part-in-interest display centered on the node S2 shown in FIG. 4, a new part-in-interest display with the node G11 as the node in interest is generated as shown in FIG. 5. Likewise, when the user selects, for example, the parent node G21 in the part-in-interest display of FIG. 4, a new part-in-interest display with the node G21 as the node in interest is generated as shown in FIG. 6.

By successively changing the node in interest as described above, various parts of the requirement structure graph are displayed in the form of a tripartite relationship among the node in interest and its parent and child.

Instead of dynamically generating the part-in-interest display information according to the node selection, a structure may be adopted in which for every node, the part-in-interest display information where the node is the node in interest is previously created and stored, the nodes displayed in a graph display or a part-in-interest display are provided with links to the corresponding part-in-interest display information and when a node is selected, its part-in-interest display information is called.

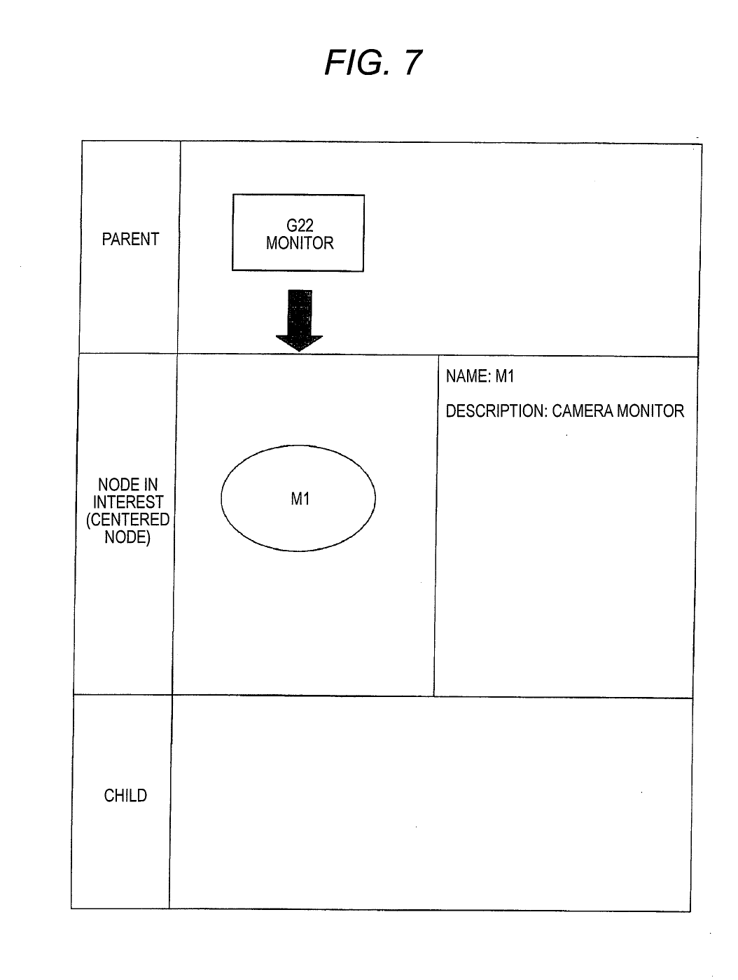

The node in interest displayed in the node-in-interest display column in the center of the part-in-interest display may be associated with, for example, information to call the link destination included in the attributes of the node. For example, in the part-in-interest display shown in FIG. 7, when the node M1 of “monitor” shown in the display column of the node in interest is selected, the module (the apparatus or the software) to be monitored corresponding to the node M1 is called, and the output of the module is displayed on the screen. For example, in a case where the apparatus to be monitored is a camera, when the node M1 is selected, the image that the camera is currently taking is supplied from the camera, and displayed on the display device 26 (e.g. the first column [the left column] of the central display column). For this, for example, link information to call the output of the camera is set at the node M1, and the camera incorporates hardware and software of communication means for supplying the taken image to the caller in response to the call. The part-in-interest display generation portion 24 and the module of the link destination communicate with each other through a network, and the output of the latter is supplied to the former.

Moreover, when a node of “evidence” is selected, the part-in-interest display generation portion 24 obtains evidence (verification result) information linked to the node, from the network, generates an image showing the information, and displays it on the display device 26.

The display information generation portion 20 illustrated above may be implemented by causing a general-purpose computer to execute a program representing the processing of the above-described functional modules. The computer has, for example, a circuit configuration in which as hardware, a microprocessor such as a CPU, memories (temporary storage) such as a random access memory (RAM) and a read-only memory (ROM), an HDD controller that controls an HDD (hard disk drive), various I/O (input/output) interfaces, a network interface that performs control for connection with a network such as a local-area network, and the like are connected, for example, through a bus. Moreover, to the bus, the following may be connected, for example, through an I/O interface: a disk drive for writing and/or reading to and/or from portable disk recording media such as a CD and a DVD; and a memory reader/writer for reading and/or writing to and/or from portable nonvolatile recording media of various standards such as a flash memory. A program where the processing contents of the functional modules illustrated above are described is stored in a fixed storage device such as a hard disk drive through a recording medium such as a CD or a DVD or through communication means such as a network, and is installed onto a computer. The program stored in a fixed storage device is read into a RAM and executed by a microprocessor such as a CPU, whereby the functional modules illustrated above are implemented.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A requirement structure display apparatus comprising:
a graph display information generation unit that, with reference to a storage unit that stores information concerning a parent-child relationship where requirement data is a parent and strategy data for refining the requirement data is a child and a parent-child relationship where the strategy data is a parent and at least one piece of requirement data obtained by refining the requirement data according to the strategy is a child, generates graph display information representing a graph constituted by the parent-child relationships between the requirement data and the strategy data;
a first specification acceptance unit that accepts a specification of the requirement data or the strategy data of an object in interest in the graph represented by the graph display information generated by the graph display information generation unit;
a part-in-interest display information generation unit that generates part-in-interest display information representing, in a direction of the parent-child relationship, the object in interest a specification of which is made to the first specification acceptance unit and a direct parent and direct child of the object in interest obtained from the information concerning the parent-child relationships stored in the storage unit; and
a display control unit that controls a display by a display unit so as to be switched from a display based on the graph display information generated by the graph display information generation unit to a display based on the part-in-interest display information generated by the part-in-interest display information generation unit based on the object in interest accepted by the first specification acceptance unit, according to the acceptance of the specification of the requirement data or the strategy data of the object in interest by the first specification acceptance unit.

2. The requirement structure display apparatus according to claim 1, further comprising a second specification acceptance unit that accepts a specification of a new object in interest from among the direct parent and direct child of the object in interest in the display represented by the part-in-interest display information,
wherein the part-in-interest information generation unit generates part-in-interest display information representing, in the direction of the parent-child relationship, a new object in interest a specification of which is made to the second specification acceptance unit and a direct parent and direct child of the new object in interest.

3. The requirement structure display apparatus according to claim 1,
wherein the storage unit further stores information concerning a parent-child relationship where requirement data is a parent and information concerning a link to an output of an apparatus or software corresponding to the requirement data is a child, and
when the information concerning the link is selected on the display based on the part-in-interest display information, the part-in-interest information generation unit accesses the apparatus or the software by using the information concerning the link, and obtains and displays the output of the apparatus or the software.

4. A non-transitory computer readable medium storing a computer readable program executable by a computer for causing a computer to execute a process, the process comprising:
with reference to storage unit for storing information concerning a parent-child relationship where requirement data is a parent and strategy data for refining the requirement data is a child and a parent-child relationship where the strategy data is a parent and at least one piece of requirement data obtained by refining the requirement data according to the strategy is a child, generating graph display information representing a graph constituted by the parent-child relationships between the requirement data and the strategy data;
accepting a specification of the requirement data or the strategy data of an object in interest in the graph represented by the graph display information generated by the generating of the graph display information;
generating part-in-interest display information representing, in a direction of the parent-child relationship, the object in interest a specification of which is made to the accepting and a direct parent and direct child of the object in interest obtained from the information concerning the parent-child relationships stored in the storage unit; and
controlling a display so as to be switched from a display based on the graph display information generated by the generating of the graph display information to a display based on the part-in-interest display information generated by the generating of the part-in-interest display information based on the object in interest accepted by the accepting, according to the acceptance of the specification of the requirement data or the strategy data of the object in interest by the accepting.

5. The process according to claim 4, further comprising:
accepting a specification of a new object in interest from among the direct parent and direct child of the object in interest in the display represented by the part-in-interest display information,
wherein the generating of the part-in-interest display information generates part-in-interest display information representing, in the direction of the parent-child relationship, a new object in interest a specification of which is made to the accepting of the specification of the new object and a direct parent and direct child of the new object in interest.

6. The process according to claim 4,
wherein the storage unit further stores information concerning a parent-child relationship where requirement data is a parent and information concerning a link to an output of an apparatus or software corresponding to the requirement data is a child, and
when the information concerning the link is selected on the display based on the part-in-interest display information, the generating of the part-in-interest display information accesses the apparatus or the software by using the information concerning the link, and obtains and displays the output of the apparatus or the software.
